(19) United States
(12) Patent Application Publication
(10) Pub. No.: US 2009/0294144 A1
(43) Pub. Date: Dec. 3, 2009

(54) Hand-held power tool

(76) Inventors: Karl Frauhammer, Leinfelden-Echterdingen (DE); Gerhard Meixner, Filderstadt (DE); Heiko Roehm, Stuttgart (DE); Willy Braun, Neustetten (DE); Axel Kuhnle, Freiberg A. N. (DE); Andreas Strasser, Rudersberg (DE); Ralph Dammertz, Stuttgart (DE); Joachim Schadow, Dettenhausen (DE); Christian Koepf, Denlendort (DE); Juergen Lennartz, Ostfildern (DE)

Correspondence Address: STRIKER, STRIKER & STENBY, 103 EAST NECK ROAD, HUNTINGTON, NY, 11743, US

(21) Appl. No.: 12/539,816

(22) Filed: Aug. 12, 2009

Related U.S. Application Data
(63) Continuation of application No. 11/326,046, filed on Jan. 5, 2006, now abandoned.

(30) Foreign Application Priority Data
Feb. 18, 2005 (DE) 10 2005007547.9

(51) Int. Cl. B25D 17/24; B25D 17/04

(52) U.S. Cl. 173/162.2; 173/217

(57) ABSTRACT

A hand-held power tool has a main element; a main handle fastened to the main element, the main handle being supported such that the main handle is movable relative to the main element, the main element including a tool fitting that defines a tool axis and the center of gravity that defines a normal direction oriented perpendicular to the tool axis and pointing toward the center of gravity, the main element being moved out of a stationary position toward the main handle so that a portion of at least 10% by weight of the main element is guided with a movement component in the normal direction along a trajectory.

### CROSS-REFERENCE

The present application is a continuation application of co-pending U.S. application Ser. No. 11/326,046. The invention described and claimed hereinbelow is also described in DE 10 2005007547.9, filed on Feb. 18, 2005. This German Patent Application, whose subject matter is incorporated here by reference, provides the basis for a claim of priority of invention under 35 U.S.C. 119 (a)-(d).

### BACKGROUND OF THE INVENTION

The present invention is directed to a hand-held power tool.

Rotary hammers are made known in publication DE 38 39 207 A1, in the case of which a rear main handle is supported such that it is movable relative to the rest of the rotary hammer. As a result of the movable support, combined with a spring element, vibration damping of the main handle is achieved, since oscillatory motions travelling from the tool toward the main handle are largely absorbed.

### SUMMARY OF THE INVENTION

Accordingly, it is an object of the present invention to provide a hand-held power tool which is a further improvement of the existing tools.

The present invention is directed to a hand-held power tool, in particular a rotary hammer and/or chisel hammer, composed of a main element and a main handle fastened to said main element, wherein said main handle is supported such that said main handle is movable relative to said main element, wherein said main element includes a tool fitting that defines a longitudinal tool axis and a center of gravity, wherein a normal direction which starts from said longitudinal tool axis and is oriented perpendicular to said longitudinal tool axis points towards said center of gravity.

In accordance with the present invention means are provided for fastening said main handle to said main element configured so that when said main element is moved out of a stationary position toward said main handle at least a portion of said main element is guided along a trajectory having a movement component in the normal direction, wherein said means for fastening said main handle to said main element are configured so that the trajectory of the portion extends with a slant of at least 10° relative to a flat surface imagined to extend through the tool axis, with the normal direction as the surface normal, in the direction of the half-space in which the center of gravity is located. As a result, not only vibrations that induce motions of the main element from the tool toward the main handle can be damped, but also vibrations that induce a movement component of the main element in the normal direction or around the center of gravity. As a result, the overall vibration damping of the main handle is improved considerably.

During operation, a hand-held power tool typically vibrates to a great extent in the direction in which it is pressed against a tool or a work piece. The extent of vibration damping of the main handle is therefore typically determined by the damping of the main handle in the working direction.

An action of force on the main element in the direction of the tool axis causes the main element to move with a rotation component, especially with hand-held power tools with which the center of gravity of the main element is far away from the tool axis.

As a result, the part of the main element facing away from the tool makes a motion that has a movement component in the direction of the tool axis and a movement component in the normal direction. Given a movability of the main element relative to the handle such that this part of the main element can oscillate in a trajectory with a movement component in the normal direction, the handle can also be at least largely decoupled from this oscillation, which is oriented perpendicularly to the tool axis.

With a hand-held power tool for shank tools, for which the present invention described here is particularly advantageous, the tool axis—which is determined by the tool fitting—extends in the longitudinal axis and/or shank axis of the shank tool. The main element can include everything fastened to the hand-held power tool except for the main handle. In addition to the main handle, the hand-held power tool can also include an additional handle.

The “stationary position” can be understood to be a position of the main handle relative to the main element in which no external forces are applied to the main handle, e.g., by an operator. In the stationary position, the main handle is typically pressed against a stop by a spring element. The portion of the main element guided in the normal direction along a trajectory with a movement component is a significant portion of the main element. A portion such as this comprises 10 percent by weight, and particularly at least 35 percent by weight of the main element, a portion of more than 50 percent by weight of the main element resulting in a particularly good vibration damping of the main handle.

The ratio of the movement component of the portion in the normal direction and the movement component of the portion in the direction of the tool axis should also be significant. The movement component of the portion in the normal direction advantageously comprises at least 18% of the total movement of the portion. In other words: The trajectory of the portion extends with a slant of at least 10° relative to a flat surface imagined to extend through the tool axis, with the normal direction as the surface normal, in the direction of the half-space in which the center of gravity is located.

Good damping can be obtained in a particularly simple, economical manner when the main handle is capable of swiveling around a single pivot axis relative to the main element, the pivot axis being located in front of a—possibly another—main element portion of at least 10 percent by weight of the main element. The directions “front” and “back” are defined relative to the tool axis, the tool fitting being located at the front of the hand-held power tool.

A particularly stable movement guidance of the handle can be obtained when the main handle is capable of being swiveled relative to the main element around at least two pivot axes. The main handle is advantageously capable of being swiveled via two rotating elements capable of being swiveled around the pivot axes and moved relative to the main handle, so that the main handle is capable of being swiveled relative to the main element, in particular around four pivot axes. Via the selection of the orientation and length of the two rotating elements relative to each other, a high degree of flexibility can be obtained in terms of adjusting the trajectory of the main element relative to the main handle.

The rotating elements can be of equal length and parallel with each other, by way of which a translatory motion of the main element on a circular trajectory around the main handle is obtainable. By selecting rotating elements having different lengths, a rotatory motion of the main element relative to the stationary main handle can be obtained in addition to the translatory motion. A rotatory motion can also be achieved when the rotating elements form an angle >0° with each other when they are in the resting position, i.e., when they are not parallel.

The selection of the trajectory of the main element relative to the stationary main handle is advantageously adapted to the main direction of oscillation that occurs during operation of the hand-held power tool and in which the part of the main element to which the main handle is fastened moves during operation. The main direction of oscillation is the direction of the greatest oscillation of the part. An adaptation occurs when the main element can carry out at least ¾ of the oscillation relative to the stationary main handle.

A simple design for fastening the main handle while ensuring a high level of flexibility in terms of selection of the trajectory can be achieved when the rotating elements are supported in individual supports in a pivoting manner at their ends facing away from the main handle, and a straight line extending through the support forms an angle >45° with the tool axis. In particular, this line is located substantially perpendicular to the tool axis.

A stable guidance of the hand-held power tool during machining of a work piece can be obtained when the movement of the main handle relative to the main element is kept in a single dimension. The possible motion that the main element can carry out relative to the main handle is therefore a purely one-dimensional motion, i.e., a purely linear motion. This linear motion can be curved.

A high damping effect can be achieved when—with the main handle remaining stationary—the main element makes a rotational movement of its own around a joint-free axis of rotation when it moves from a stationary position and approaches the main handle. This axis of rotation does not pass through a pivotal point. Instead, it passes a site that is favorable for vibration damping, e.g., through a motor housing or entirely outside of the hand-held power tool.

It is also possible that the axis of rotation itself shifts in the space while the main element moves relative to the main handle, i.e., the trajectory of the main element relative to the stationary main handle therefore being a translatory motion combined with a rotational movement of its own. As an alternative, it is possible to design the axis of rotation as a joint, by way of which the main handle is guided relative to the main element.

Advantageously, the entire joint-free or jointed axis of rotation is located in front of the main handle, the main handle being located behind the tool fitting relative to the tool axis. The location of the main handle behind the tool fitting is not intended to be a limitation. Instead, it is intended to define the direction for the axis of rotation located in front of the main handle. When the axis of rotation is located here, a high level of vibration damping can be obtained with main elements, the center of gravity of which is located at a relatively great distance from the tool axis. With main elements of this type, the location of the axis of rotation below a motor housing is particularly advantageous. It is also advantageous to locate the axis of rotation in front of the center of gravity and, in particular, below the center of gravity. The spacial direction “below” is intended to mean that the tool axis is located above the center of gravity.

A good damping of oscillations oriented in various directions can be obtained when the main element is movable relative to the main handle substantially in a plane that extends through the tool axis and in the normal direction. The main element is movable in two dimensions. The movability is essentially in the plane when the movability is given with a deviation of up to 5 mm and 10° relative to the plane. As a result of the guidance, a three-dimensional movability in the space is ruled out.

In a further advantageous embodiment of the present invention, the main handle is supported such that it is displaceable relative to the main element via at least two parallel guides.

The present invention is particularly suited for hand-held power tools with a motor axis oriented substantially perpendicularly to the tool axis. Hand-held power tools of this type are, e.g., a large drill, a rotary hammer, a rotary and chisel hammer, or a chisel hammer.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 Shows a side view of a rotary hammer with the housing removed,

FIG. 2 Shows a schematic depiction of the rotary hammer in FIG. 1 with the tool axis and center of gravity sketched in,

FIG. 3 Shows the schematic depiction in FIG. 3 with an additional displacement of a main element of the hand-held power tool caused by a trajectory,

FIG. 4 Shows a side view of a further rotary hammer with a somewhat different damping element,

FIG. 5 Shows a schematic depiction of the hand-held power tool in FIG. 4,

FIG. 6 Shows a schematic depiction of the trajectory of the main element of the hand-held power tool in FIGS. 4 and 5,

FIG. 7 Shows a side view of a further rotary hammer with a damping element capable of moving around only one axis of rotation,

FIG. 8 Shows the motion of the main element of the hand-held power tool in FIG. 7 around the axis of rotation,

FIG. 9 Shows a hand-held power tool with an insertable damping element,

FIG. 10 Shows the trajectory of the main element of the hand-held power tool in FIG. 9,

FIG. 11 Shows a hand-held power tool with a damping element with two elastomer strips, and

FIG. 12 Shows a motion of the main element corresponding to the deformation of the elastomer strips.

### DESCRIPTION OF THE PREFERRED EMBODIMENTS

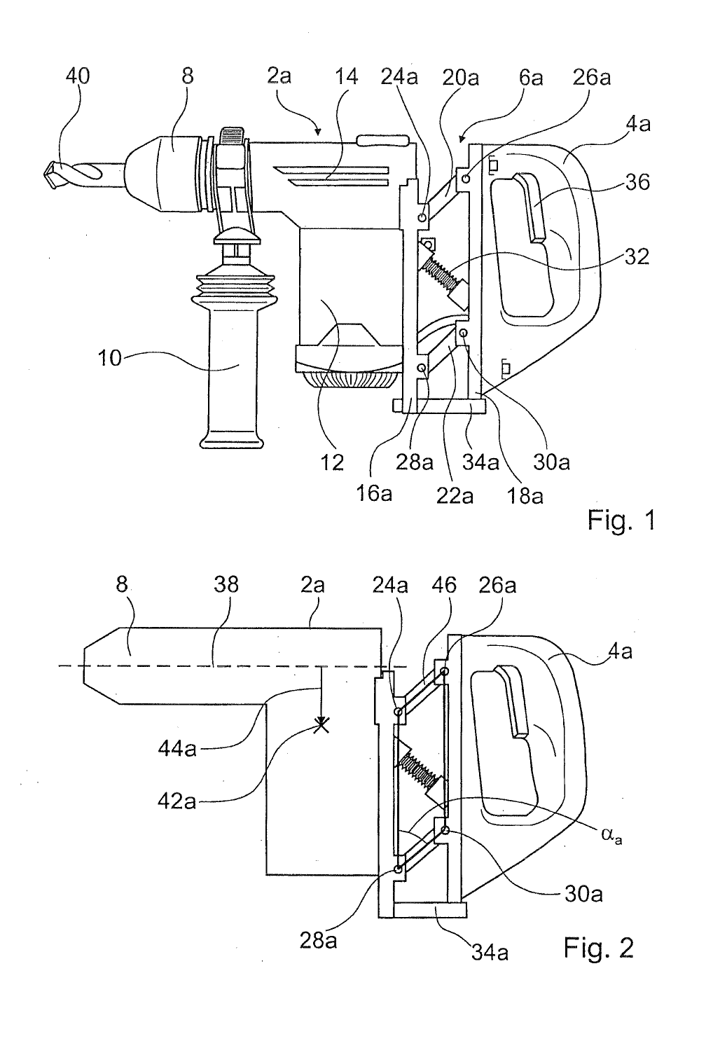

FIG. 1 shows a hand-held power tool in the form of a rotary hammer. The hand-held power tool includes a main element 2a and a main handle 4a, which is fastened to main element 2a via a damping element 6a. Main element 2a includes a tool fitting 8, an additional handle 10, a motor 12 which is located inside a motor housing—and an impact mechanism 14, which is also hidden behind an inner housing.

Damping element 6a includes two connecting elements 16a, 18a, which are interconnected by two rotating elements 20a, 22a such that they are movable relative to each other. Rotating elements 20a, 22a are supported such that they can each rotate around two pivot axes 24a, 26a, 28a, 30a, so that main handle 4a is capable of swiveling relative to main element 2a around the four pivot axes 24a, 26a, 28a, 30a. Pivot axes 24a, 26a, 28a, 30a are formed by supports, by way of which rotating elements 20a, 22a are pivotably supported.

Connecting elements 16a, 18a are pressed apart by a spring element 32, so that connecting element 18a rests against a stop 34a. In the position shown in FIG. 1, the hand-held power tool is in the stationary position, and no external forces act on main element 2a or main handle 4a. Main handle 4a includes all rigidly interconnected elements of main handle 4a, including a switch 36 and the elements connected therewith, e.g., connecting element 18a. All remaining elements of damping element 6a are assigned to main element 2a. Main element 2a can carry additional elements not shown in the Figures.

FIG. 2 shows the hand-held power tool in FIG. 1 with a schematically indicated main element 2a. A tool axis 38 is indicated, the tool axis being determined by tool fitting 8 and a tool 40 clamped fixedly therein. Also shown is a center of gravity 42a of main element 2a, which is located, e.g., below tool axis 38. A normal direction 44a that points downward extends perpendicularly from tool axis 38 and points toward center of gravity 42a. To illustrate the stationary position, a trapezoid 46 that symbolically connects pivot axes 24a, 26a, 28a, 30a is shown.

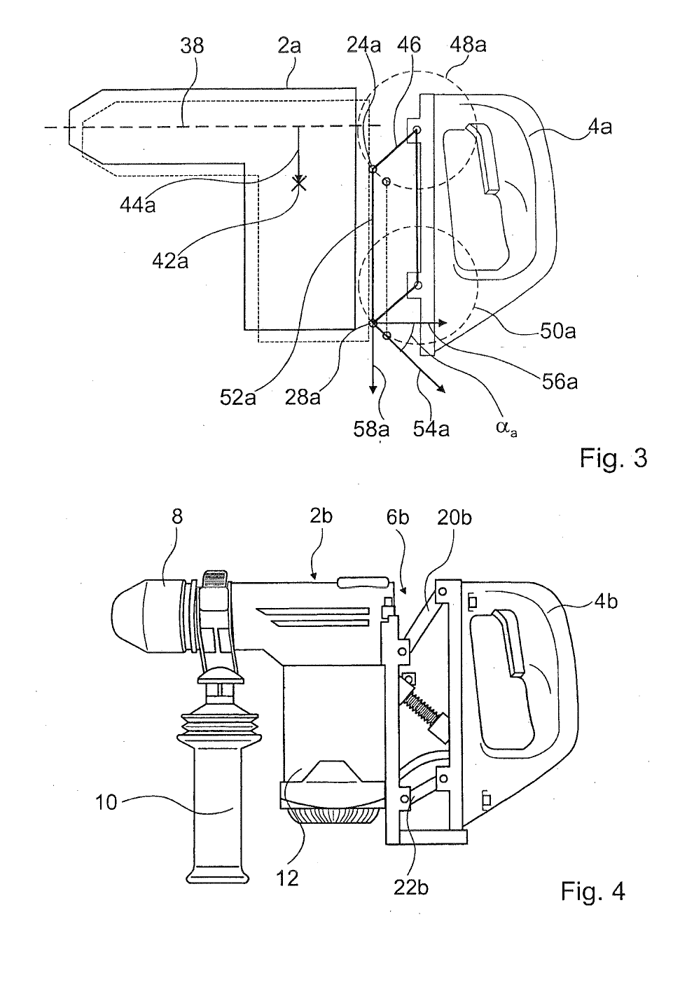

A further schematization of the hand-held power tool in FIGS. 1 and 2 is shown in FIG. 3. Trapezoid 46 is also shown in the stationary position. When main handle 4a moves relative to main element 2a or when main element 2a makes an equivalent motion relative to stationary main handle 4a, main element 2a is displaced, e.g., out of the stationary position indicated by a solid line into the position indicated by the dashed line. Pivot axis 24a moves in the counterclockwise direction on a circular trajectory 48a, and pivot axis 28a moves in the counterclockwise direction on a circular trajectory 50a. A line 52a of trapezoid 46 imagined to connect pivot axes 24a and 28a is displaced from the position indicated by the solid line into the position indicated by the dashed line. Main element 2a is thereby displaced on a circular trajectory in a direction of motion 54a.

Direction of motion 54a is composed of a movement component 56a parallel to tool axis 38 and a movement component 58a parallel to normal direction 44a. In this manner, main element 2a is guided in normal direction 44a along a trajectory with a movement component 58a. Or—in other words—main handle 4a, when moved out of its stationary position toward main element 2a, is guided in a direction of motion 54a at an angle to tool axis 38. Stop 34a should be designed such that a slant with an angle αₐ of at least 10°, in particular at least 20°, is given.

With a hand-held power tool such as the one shown in FIGS. 1 through 3, the trajectory of main element 2a remains in the plane of the page and is therefore a one-dimensional, circular linear motion. In this manner, oscillation of main element 2a in direction of motion 54a can be largely absorbed by damping element 6a, main element 2a being capable of oscillating freely while main handle 4a remains stationary.

Direction of motion 54a may include an additional movement component perpendicular to movement components 56a and 58a if, e.g., circular trajectories 48a and 50a are not exactly parallel to normal direction 44a; this does not substantially affect the principles of the present invention.

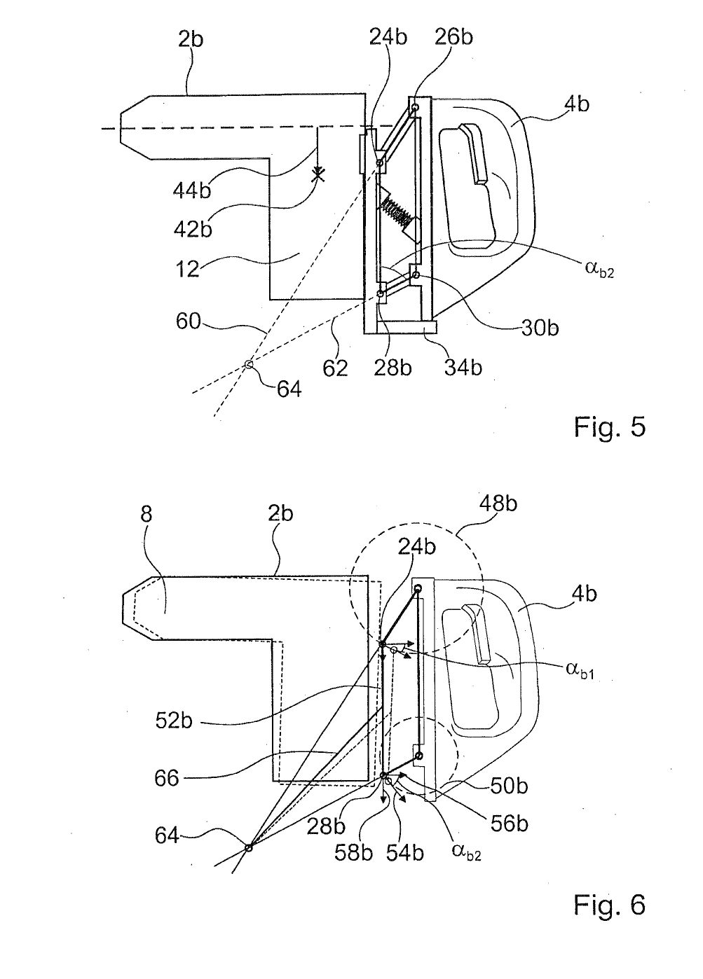

FIG. 4 shows a further hand-held power tool that is very similar to the hand-held power tool shown in FIGS. 1 through 3, with the only difference being that it has a slightly different damping element 6b. Refer to the description of the exemplary embodiment in FIGS. 1 through 3 for the features and functionalities that are the same. The description below is essentially limited to the differences from the exemplary embodiment in FIGS. 1 through 3. Damping element 6b includes two rotating elements 20b, 22b having different lengths and that are oriented at an angle of approximately 30° relative to each other. As a result, lines 60, 62 shown in FIG. 5—which extend through pivot axes 24b, 26b—intersect at an axis of rotation 64.

A motion of main element 2b out of the stationary position indicated by a solid line into a position indicated by a dashed line is indicated schematically in FIG. 6. A motion of this type results in main element 2b approaching main handle 4b and results in pivot axes 24b, 28b moving in the counterclockwise direction on circular trajectories 48b, 50b. A line 52b that connects pivot axes 24b, 28b is thereby moved out of the stationary position indicated by the solid line into the position indicated by the dashed line. While, as shown in FIG. 3, main element 2a was displaced downward and rearward in parallel i.e., entire main element 2a has the same movement components 58a in normal direction 44a, when main element 2b moves, main element 2b also makes a rotational movement of its own in addition to the parallel displacement shown in FIG. 3. This combined motion causes main element 2b to rotate around axis of rotation 64.

Nearly the entire main element 2b makes a motion with a movement component 58b in normal direction 44b, the portion of movement components 58b involved in direction of motion 54b in the lower part of main element 2b comprising more than 50% and decreasing in the upward direction. In the region of tool fitting 8, main element 2b makes a slight motion upward, so that it is guided there along a trajectory with a movement component opposite to normal direction 44b. A portion of more than 90% of main element 2b has a movement component 58b in normal direction 44b, however. A stop 34b is designed such that direction of motion 54b has a slant with an angle α_{b1} of approximately 30° or an angle α_{b2} of approximately 60°. The slant or tilt is directed downward, i.e., toward a flat surface imagined to extend through tool axis 38 with normal direction 44b as the surface normal, in the direction of the half-space in which the center of gravity is located.

To illustrate the rotation of main element 2b around axis of rotation 64, a further, randomly positioned line 66 is connected to line 52b and extended toward axis of rotation 64. When line 66 is moved rigidly with line 52b out of the resting position into the position indicated by a dashed line, line 66 is moved out of the position indicated by the solid line into the position indicated by the dashed line. The end of dashed line 66 remains at an extremely small distance away from axis of rotation 64, thereby clearly showing that axis of rotation 64 does not remain statically stationary by the motion of main element 2b, but rather makes a very small motion. Axis of rotation 64 is located outside of the hand-held power tool and, in fact, in front of main handle 4b, and in front of and behind center of gravity 42b and motor 12.

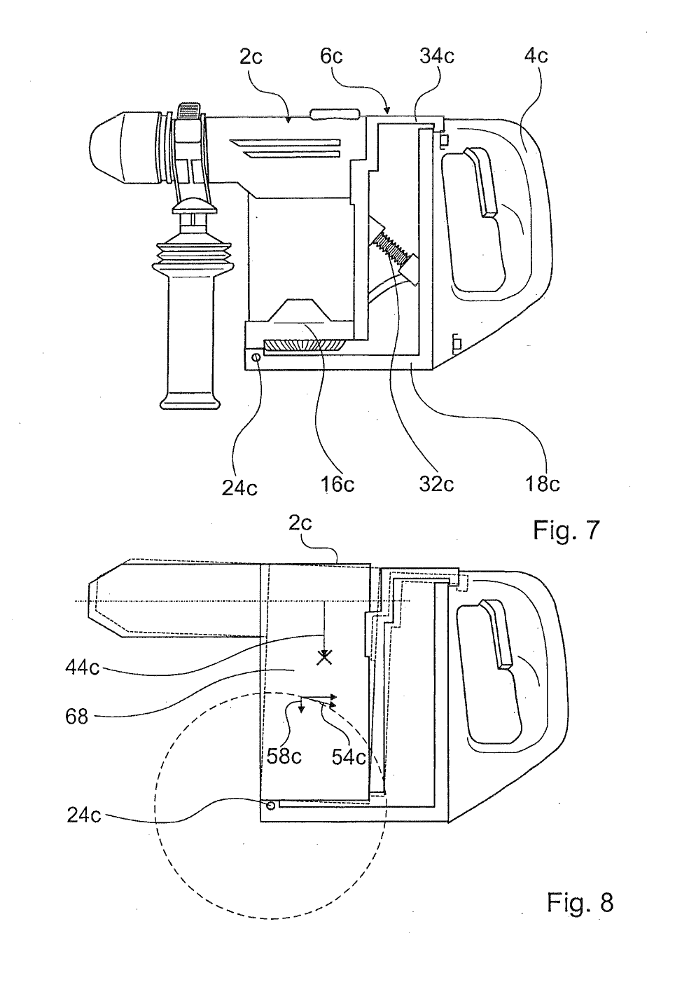

Shown in FIG. 7 is a further hand-held power tool with a main element 2c, a main handle 4c and a damping element 6c. Damping element 6c includes two connecting elements 16c, 18c, which are fastened together such that they are rotatable on a pivot axis 24c. Connecting element 16c includes a stop 34c that encompasses connecting element 18c and therefore creates a stationary position as shown in FIG. 7, into which connecting elements 16c, 18c are pressed by spring element 32. When an operator moves main element 2c and main handle 4c toward each other, entire main element 2c moves out of the stationary position shown in FIG. 7 and into a position shown in FIG. 8 as a dashed line, thereby rotating around pivot axis 24c. A portion 68 of main element 2c is moved far downward, so that its trajectory in direction of motion 54c has a small movement component 58c in normal direction 44c. This portion 68 includes more than half of the weight component of main element 2c.

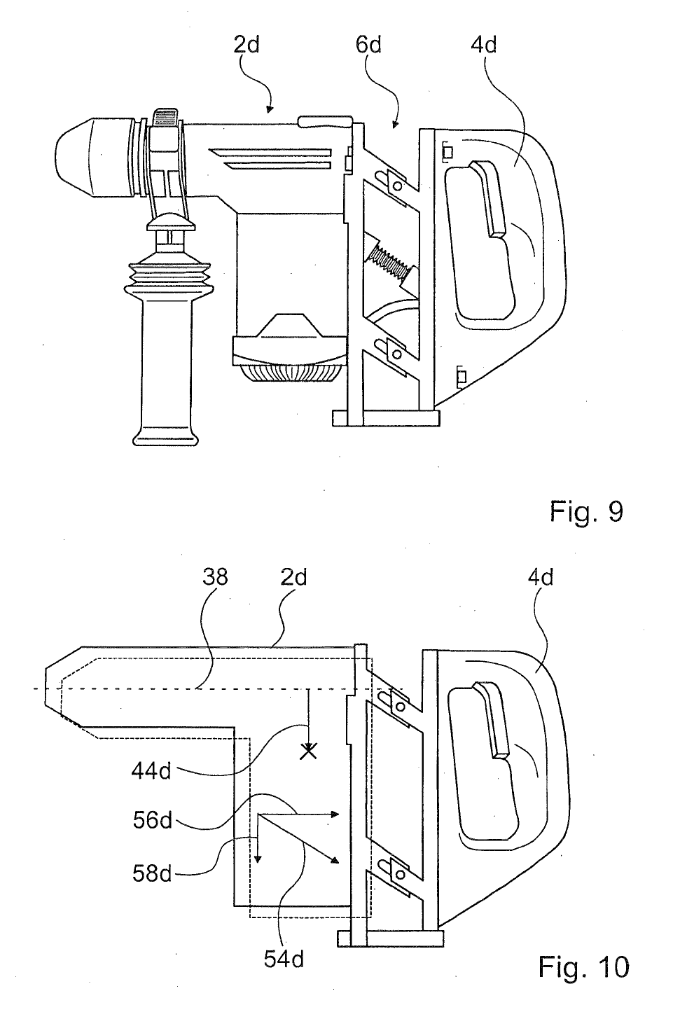

A further exemplary embodiment is shown in FIGS. 9 and 10. A main handle 4d of a rotary hammer is supported on a main element 2d such that it is displaceable by a damping element 6d. When main handle 4d is pressed in the direction toward main element 2d, main element 2d and main handle 4d are moved toward each other, main element 2d—as shown in FIG. 10—being displaced out of the resting position into the position indicated by the dashed line. Entire main element 2d is displaced on a trajectory in direction of motion 54d, which has a movement component 58d in normal direction 44d and a somewhat greater movement component 56d parallel to tool axis 38.

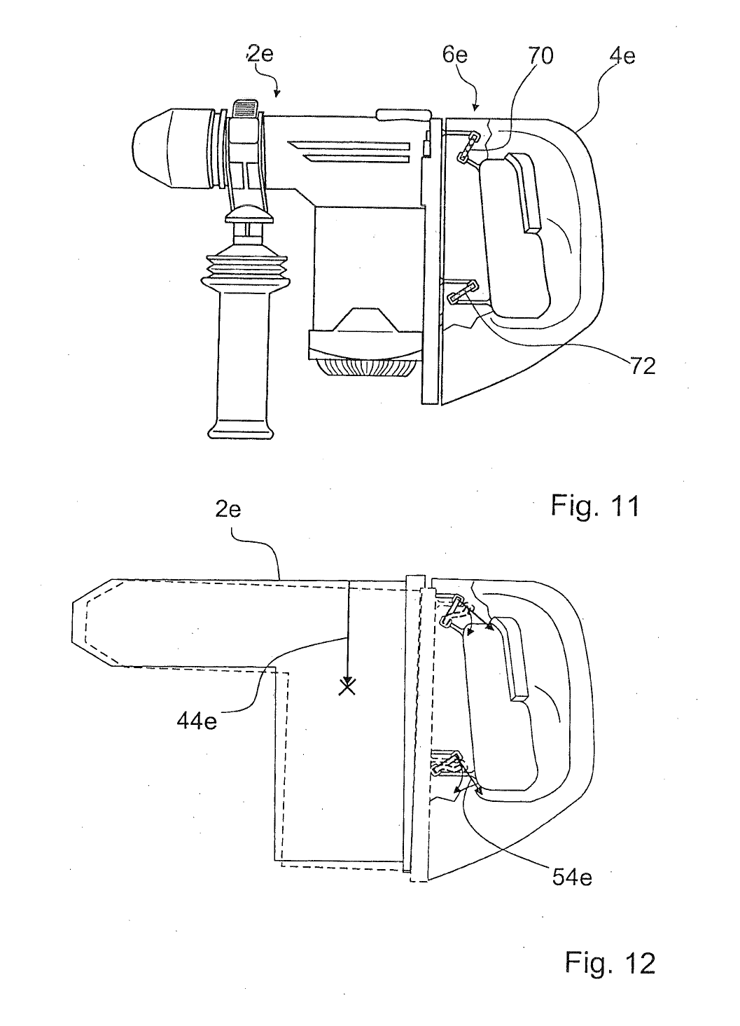

A further exemplary embodiment with a connecting element 6e with elastomer strips 70, 72 is shown in FIGS. 11 and 12. Elastomer strips 70, 72, which have their greatest expansion perpendicular to the plane of the page in FIGS. 11 and 12, connect a main element 2e with a main handle 4e. Although they are bendable, as shown in FIG. 12, they are essentially fixed in their longitudinal extension, so that they only permit a circular motion to be carried out, as indicated in FIG. 12 by arrows. The resultant motion of main element 2e is one-dimensional, i.e., in a curved line, and is guided with a movement component 54e in normal direction 44e.

It will be understood that each of the elements described above, or two or more together, may also find a useful application in other types of constructions differing from the types described above.

While the invention has been illustrated and described as embodied in hand-held power tool, it is not intended to be limited to the details shown, since various modifications and structural changes may be made without departing in any way from the spirit of the present invention.

Without further analysis, the foregoing will reveal fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A hand-held power tool, comprising:
a main element;
a main handle fastened to said main element, said main handle being supported such that said main handle is movable relative to said main element, said main element including a tool fitting that defines a longitudinal tool axis and a center of gravity, wherein a normal direction that originates from said longitudinal tool axis and is oriented perpendicular to said longitudinal tool axis points toward said center of gravity; and
means for fastening said main handle to said main element configured so that when said main element is moved out of a stationary position toward said main handle at least a portion of said main element is guided along a trajectory having a movement component in the normal direction, wherein said means for fastening said main handle to said main element are configured so that the trajectory of the portion extends with a slant of at least 10° relative to an imaginary flat surface extending through the tool axis, with the normal direction as the surface normal, in a direction of a half-space in which the center of gravity is located.

2. The hand-held power tool as defined in claim 1, wherein means for fastening is configured so that said main handle is swivelable around at least two swivel axes relative to said main element.

3. The hand-held power tool as defined in claim 2, wherein said means for fastening include two rotating elements configured so that said main handle is swivelable via said two rotating elements around said two swivel axes and relative to said main element.

4. The hand-held power tool as defined in claim 3, wherein said rotating elements have different lengths.

5. The hand-held power tool as defined in claim 3, wherein said rotating elements are each supported in a support at their ends facing away from said main handle, and a straight line extending through the supports form an angle >45° with said tool axis.

6. The hand-held power tool as defined in claim 1, wherein said means for fastening is configured so that the motion of said main handle relative to said main element is kept within a single dimension.

7. The hand-held power tool as defined in claim 1, wherein said main handle is stationary, said main element making a rotational movement around a joint-free axis of rotation when it moves from a stationary position and approaches said main handle.

8. The hand-held power tool as defined in claim 7, wherein said main handle, relative to said tool axis, is located behind said tool fitting, and said axis of rotation is located completely in front of said handle.

9. The hand-held power tool as defined in claim 7, wherein said main handle, relative to said tool axis is located behind said tool fitting, and said axis of rotation as a whole is located in front of said center of gravity.

10. The hand-held power tool as defined in claim 1, wherein said portion is a portion of at least 10% by weight of said main element.

11. The hand-held power tool as defined in claim 1, wherein said means for fastening said main handle to said main element are configured so that the movement component of the portion in the normal direction comprises at lest 18% of the total movement of the portion.

12. The hand-held power tool as defined in claim 1, wherein said means for fastening said main handle to said main element are configured so that said trajectory of said portion extends with a slant of at lest 20° relative to said flat surface.

13. The hand-held power tool as defined in claim 1, wherein said means for fastening said main handle to said main element are configured so that said trajectory of said portion extends with a slant of at least 30° relative to said flat surface.

14. The hand-held power tool as defined in claim 1, wherein said means for fastening said main handle to said main element are configured so that said trajectory of said portion extends with a slant of at lest 60° relative to said flat surface.

15. The hand-held power tool as defined in claim 1, wherein said means for fastening said main handle to said main element are configured so that said trajectory is a one-dimensional, circular motion.

16. The hand-held power tool as defined in claim 6, wherein said means for fastening said main handle to said main element are configured so that said trajectory is straight.

17. The hand-held power tool as defined in claim 16, comprising at least one parallel guide, wherein said parallel guide supports the main handle such that the main handle is displaceable relative to the main element in a translational motion.

18. The hand-held power tool as defined in claim 1, comprising a motor with a motor axis oriented substantially perpendicularly to the tool axis.

19. The hand-held power tool as defined in claim 1, comprising a stop which is designed such that the trajectory of the portion starts from the stationary position with a slant of at least 10° relative to the flat surface.

20. The hand-held power tool as defined in claim 1, further comprising a spring element, wherein said means for fastening are configured so that said main handle is swivelable around at least one swivel axis relative to said main element, wherein said means for fastening include at least one rotating element configured so that said main handle is swivelable via said rotating element around said swivel axis and relative to said main element, wherein said spring element extends mainly in a selected direction, wherein said selected direction includes only angles relative to the surface that are greater than 10°, wherein the selected direction is substantially perpendicular to a direction in which the rotating element extends mainly when the main element is in the stationary position.

21. The hand-held power tool as defined in claim 20, wherein the direction in which the spring element extends includes only angles relative to the surface that are greater than 30°.

22. A hand-held power tool, comprising:
a main element;
a main handle fastened to said main element, said main handle being supported such that said main handle is movable relative to said main element, said main element including a tool fitting that defines a longitudinal tool axis and a center of gravity, wherein a normal direction that is oriented perpendicular to said longitudinal tool axis points toward said center of gravity; and
means for fastening said main handle to said main element configured so that when said main element is moved out of a stationary position toward said main handle, said main element is guided along a trajectory having a movement component in the normal direction, wherein said means for fastening said main handle to said main element are configured so that said main element performs a relative movement to the main handle during its movement on the trajectory, wherein the relative movement is a rotation about a single axis.
